(19) United States
(12) Patent Application Publication
(10) Pub. No.: US 2025/0172585 A1
(43) Pub. Date: May 29, 2025

(54) SCANNING PROBE MICROSCOPE AND METHOD OF ALIGNMENT, FOCUSING, AND MEASUREMENT

(71) Applicant: MOLECULAR VISTA, INC., San Jose, CA (US)

(72) Inventors: William Morrison, San Jose, CA (US); Padraic O'Reilly, San Jose, CA (US); Derek Nowak, San Jose, CA (US)

(21) Appl. No.: 18/834,204

(22) PCT Filed: Feb. 3, 2023
(86) PCT No.: PCT/US23/12271

§ 371 Date: Jul. 29, 2024

(51) Int. Cl. G01Q 20/02; G01Q 40/00; G01Q 60/18

(52) U.S. Cl. CPC G01Q 20/02; G01Q 40/00; G01Q 60/18

(57) ABSTRACT

A scanning probe microscope and method of operating the scanning probe microscope selects a preferred focus position of a focused optical beam on a probe of the scanning probe microscope by adjusting a focus position of the focused optical beam on the probe relative to a tip of the probe and then measuring at least one of a response of the probe and optical radiation scattered from the probe as a function of the position of the focused optical beam. The preferred focus position of the focused optical beam on the probe is based on the measuring of the at least one of the response of the probe and the optical radiation scattered from the probe.

### CROSS REFERENCE TO RELATED APPLICATION

This application is entitled to the benefit of U.S. Provisional Patent Application Ser. No. 63/306,450, filed on Feb. 3, 2022, which is incorporated herein by reference.

### BACKGROUND OF THE INVENTION

In scanning probe microscopy (SPM) techniques which rely on illumination of the tip-sample interface by an optical beam in order to measure optical or other sample properties in the near field region around the tip, alignment of the optical beam to the tip is of critical importance. Moreover, with measurements that involve tunable laser sources where multiple wavelengths are used for a spectroscopic measurement, it is also of critical importance to measure the local fluence incident on the tip. As used herein, fluence is the radiant energy received by a surface per unit area. Measurement of the fluence can then be used to normalize the optical response of the sample by removing the effects of laser power variation, optical losses in the beam path and spot size as a function of wavelength. Existing methods of alignment and fluence measurement, which rely on measuring a response when the tip is engaged with the sample surface, are adversely affected by local surface properties of the sample, including topographic, mechanical, and optical properties. These local surface properties of the sample can result in beam alignment, which is neither optimal nor repeatable, rendering the measurements less reliable. The local surface properties will also be contained in any background spectrum obtained directly affecting spectral normalization, in spectroscopic measurements that involve a tunable light source.

In addition, having the tip in close proximity with the sample surface introduces some risk of tip damage if the optical interaction causes too large a vibration of the tip and the tip contacts the surface. Furthermore, such tip-surface interaction can damp or limit tip vibration amplitude, complicating the alignment procedure, and limiting the speed and signal-to-noise ratio of the measurement of tip response during the alignment by limiting the amplitude to a small value.

### SUMMARY OF THE INVENTION

A scanning probe microscope and method of operating the scanning probe microscope selects a preferred focus position of a focused optical beam on a probe of the scanning probe microscope by adjusting a focus position of the focused optical beam on the probe relative to a tip of the probe and then measuring at least one of a response of the probe and optical radiation scattered from the probe as a function of the position of the focused optical beam. The preferred focus position of the focused optical beam on the probe is based on the measuring of the at least one of the response of the probe and the optical radiation scattered from the probe.

A method of operating a scanning probe microscope using a focused optical beam on a probe of the scanning probe microscope in accordance with an embodiment of the invention comprises shining the focused optical beam on the probe of the scanning probe microscope without a presence of a sample to interact with the focused optical beam on the probe, adjusting a focus position of the focused optical beam on the probe relative to a tip of the probe, measuring at least one of a response of the probe and optical radiation scattered from the probe as a function of the position of the focused optical beam; and selecting a preferred focus position of the focused optical beam on the probe based on the measuring of the at least one of the response of the probe and the optical radiation scattered from the probe.

A method of operating a scanning probe microscope using a focused optical beam on a probe of the scanning probe microscope in accordance with an embodiment of the invention comprises shining the focused optical beam on the probe of the scanning probe microscope without a presence of a sample to interact with the focused optical beam on the probe, adjusting a focus position of the focused optical beam on the probe relative to a tip of the probe, measuring a response of the probe as a function of the position of the focused optical beam, and selecting a preferred focus position of the focused optical beam on the probe based on the measuring of the response of the probe.

A scanning probe microscope in accordance with an embodiment of the invention comprises a cantilever with a probe, a light source to irradiate the probe with a focused optical beam, an optical system to adjust a focus position of the focused optical beam on the probe, a dither device connected to the cantilever to drive the cantilever to vibrate, an optical detection system to measure a response of the probe with respect to the focused optical beam, and a control unit connected to the optical system and the optical detection system to select a preferred focus position of the focused optical beam on the probe based on the measured response of the cantilever for different adjusted focus positions of the focused optical beam on the probe.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows an example of a scanning probe microscope that relies on illumination of the tip-sample interface with an optical beam on which embodiments of the invention may be applied.

FIG. 2 illustrates a beam waist of a focused light beam, a tip of a probe on a cantilever of a scanning probe microscope, and the direction of the resulting trapping force in accordance with an embodiment of the invention.

FIG. 3 illustrates detecting light scattered by a probe tip in the presence of a focused incoming beam in accordance with an embodiment of the invention.

FIG. 4 shows the scanning probe microscope of FIG. 1 with a beamsplitter and a scattered light detector in accordance with an embodiment of the invention.

FIG. 5 illustrates dynamic correction of beam alignment using the position of a focusing element 502 and the angle of a steering mirror in accordance with an embodiment of the invention.

FIG. 6 is a process flow diagram of a method of operating a scanning probe microscope using a focused optical beam on a probe of the scanning probe microscope in accordance with an embodiment of the invention.

Throughout the description, similar reference numbers may be used to identify similar elements.

### DETAILED DESCRIPTION

In view of the issues with respect to the alignment of the optical beam to the probe tip for a scanning probe microscope that relies on illumination of the tip-sample interface, as described above, what is needed is an alignment method for aligning the optical beam and measuring the local fluence on the tip of the probe in “free space”, i.e., without the presence of a sample, for example, without bringing the probe tip into measuring proximity with a surface of a sample so that there is no interaction between the probe and the sample. As used herein, the measuring proximity is when the surface of a sample is brought close enough to a probe tip such that there is interaction between the probe and the sample when an optical beam is focused on the probe. An optical alignment method which does not require the presence of a sample is free of adverse effects caused by local properties of the sample surface.

Embodiments of the invention include a method for free-space alignment of an optical beam optimally with respect to a probe tip and for measurements of the intensity at different wavelengths to be used for normalization. After alignment and intensity measurements, the surface of the sample is brought into measuring proximity with the tip and the beam aligned to the tip, and no further adjustment of the alignment is needed. This alignment method provides optimal and repeatable measurement results, regardless of the properties of the sample.

There are a variety of SPM techniques which rely on optical illumination of the tip-sample interface, including photothermal induced resonance (PTIR), photo-induced force microscopy (PiFM), scanning scattering near-field optical microscopy (sSNOM), and tip-enhanced Raman spectroscopy/microscopy. A procedure for aligning and determining the fluence of a focused optical beam to the tip-sample interface is needed for all such techniques. For several of these techniques, a tunable infrared (IR) laser source may be used for the purpose of measuring wavelength-dependent optical properties of the sample at high spatial resolution, such as the generation of local IR absorption spectra for the purpose of identifying materials. When tunable sources are used, not only is it necessary to statically align and determine the fluence of the focused beam to the tip-sample interface; dynamic changes in steering and focus as the wavelength of the optical source is changed may require that the position and/or focus of the beam is frequently or even continuously adjusted for optimal performance when the wavelength is changed.

One method of making such adjustment is described in U.S. Pat. No. 8,242,448 by Prater et al. “Dynamic Power Control, Beam Alignment and Focus for Nanoscale Spectroscopy.” In this patent, a method of obtaining wavelength dependent optical property measurements of a sample, with a probe microscope and an IR radiation source tunable over a range of wavelengths, as recited in Claim 1, includes (a) interacting a probe of the probe microscope with a region of the sample, (b) adjusting a position of a beam of radiation emitted from the radiation source with a beam steering mechanism, (c) directing a beam from the radiation source and beam steering mechanism at the region of a sample under the probe, (d) measuring a response of the probe due to an interaction of radiation with the sample at least one wavelength of radiation, and (e) automatically adjusting the beam steering mechanism to substantially maximize the measured probe response.

Although this method is useful for aligning an optical beam to the tip-sample interface, the presence of an unknown sample surface introduces uncontrolled variables due to local sample topography, mechanical properties such as stiffness and damping, and optical properties, such as transmission, scattering, or absorption. These uncontrolled variables can result in alignment which is neither optimal nor repeatable. Furthermore, having the tip in close proximity of the sample surface limits the available working range of tip vibration amplitude, which negatively impacts speed and signal to noise ratio of vibration amplitude measurement. Embodiments of the invention, as described herein, eliminates these issues.

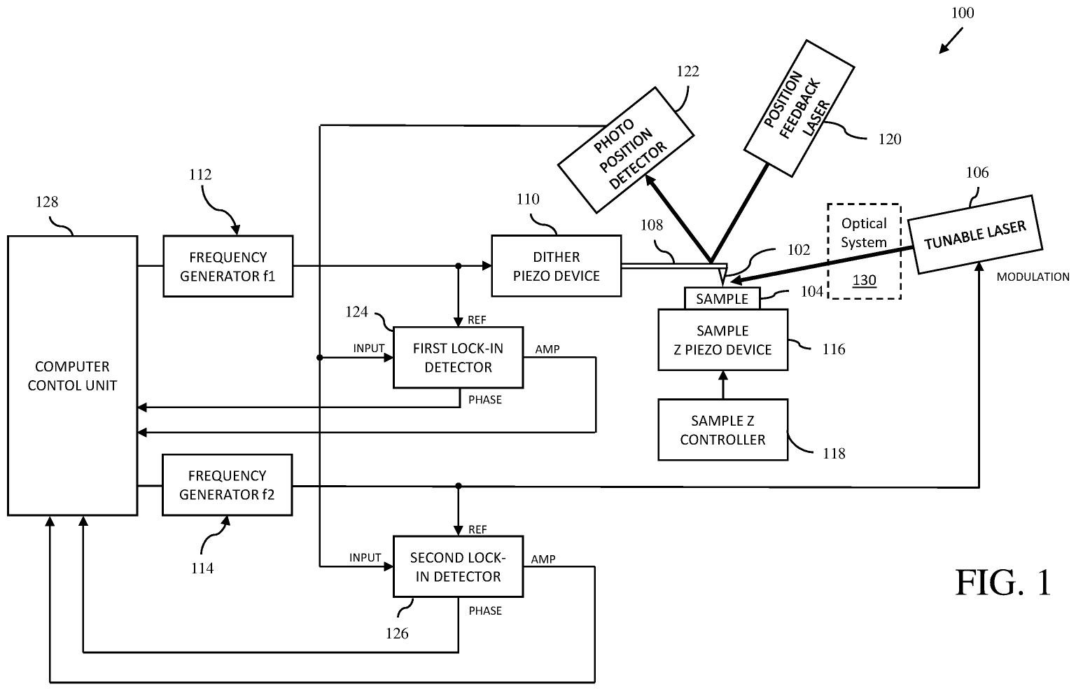

An example of a scanning probe microscope 100 that relies on illumination of the tip-sample interface with an optical beam on which embodiments of the invention may be applied is illustrated in FIG. 1. As shown in FIG. 1, the scanning probe microscope 100 uses a focused optical beam on a probe 102 of the microscope in order to measure optical or other sample properties of a sample 104 of interest in the near field region around the tip of the probe. The focus optical beam is provided by a light source 106, which may be a tunable infrared (IR) laser.

The probe 102 is attached to a cantilever 108, which is coupled to a dither piezo device 110 to vibrate the cantilever 108. The dither piezo device 110 is controlled by a first frequency generator 112, which provides a driving signal at frequency f1 to the dither piezo device 110.

The tunable laser 106 is controlled by a second frequency generator 114, which provides a driving or modulation signal at frequency f2 to the tunable laser 106. Thus, the optical beam from the tunable laser 106 to the probe 102 can be modulated at frequency f2.

The sample 104 of interest is placed on a sample z piezo device 116, which can move the sample in the z-direction, i.e., towards or away from the probe 102. The sample z piezo device 116 is controlled by a sample z controller 118, which may move the sample z piezo device as needed. When the optical beam from the tunable laser 106 is being aligned, as described herein, the sample 104 can be removed from the scanning probe microscope 100 or moved sufficiently away from the probe 102 so that the alignment can be performed in “free space”.

As shown in FIG. 1, the scanning probe microscope 100 further includes a position feedback laser 120, a photo position detector 122, a first lock-in detector or amplifier 124 and a second lock-in detector or amplifier 126. The photo position detector 122 operates to optically measure the vibration of the cantilever 108 using light from the position feedback laser 120 reflected off the cantilever. The signal from the photo position detector 122 is input to the first lock-in amplifier 124, which can provide amplitude and phase of the cantilever vibration using the driving frequency f1 as a reference. The first lock-in amplifier 124 may also provide an amplitude error signal to the sample z controller 118 so that the spacing between the probe tip and the sample 104 is maintained at a desired spacing. The position feedback laser 120, the photo position detector 122 and the first lock-in detector 124 are part of an optical detection system, which can measure one or more responses of the probe 102 with respect to the focused optical beam from the tunable laser 106 during an alignment process, as described herein.

The signal from the photo position detector 122 is also input to the second lock-in amplifier 126, which can provide amplitude and phase of the cantilever vibration to a computer control unit 128 using the modulation frequency f2 as a reference. The amplitude and phase signals from the first and second lock-in amplifiers 124 and 126 are transmitted to a computer control unit 128, which can process the received signals. The computer control unit 128 can also control the frequency generators 112 and 114 to adjust the frequencies f1 and f2 that are produced, which may at least partly be in response to the received phase and/or amplitude signals. In addition, the computer control unit 128 can adjust a focus position of a focused optical beam from the tunable laser 106 using an optical system 130, which may include one or more steering mirrors and one or more focusing elements that are controllable by the computer control unit. In an embodiment, alignment of the optical beam from the laser 106 to the optical axis of the focusing optics or element is done by a steering mirror. Once this is done, the focusing optic is moved using piezos (fine movements) and stepper motors (coarse movements) in XYZ to map out the focal spot. After the spot is found and mapped out. the focal spot is moved so that the focus correlates with the probe tip. In an alternative embodiment, the probe tip may be moved instead of moving the optical beam.

Optical alignment of a focused beam of light to the probe tip of a scanning probe microscope, such as the scanning probe microscope 100 shown in FIG. 1, is performed by positioning the focus of a light beam in the vicinity of the probe tip (in “free space,” without a sample surface nearby), and measuring either the mechanical vibration of the cantilever probe or detecting the scattered light from the probe tip as a function of focus position. The optimal focus position may be the position where maximum amplitude of vibration or intensity of scattered light is observed, or an empirically-derived offset from such position. Alternatively, the optimal focus position may be determined by measuring the phase of vibration (relative to a driving source) or the resonant frequency of the cantilever probe. When aligning by means of measuring vibration amplitude or phase, the focused light beam may be modulated, preferably at or near a resonant frequency of the cantilever probe. After the optical alignment procedure is complete, the local fluence profile can be measured by measuring the signal strength of either the mechanical vibration of the cantilever probe or detecting the scattered light from the probe tip as the wavelength of the light source is varied. This local fluence profile provides the normalization information required to correct the optical response of the sample mathematically or dynamically in real-time.

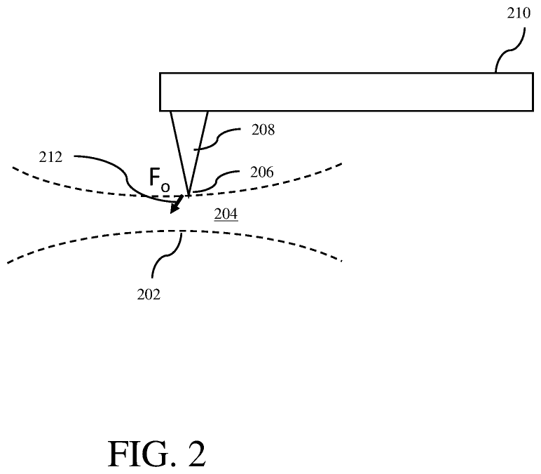

Focusing an optical beam on a cantilever probe affects the properties of the probe in at least three ways. First, absorption of light can heat the cantilever probe, causing deflection of the probe due to thermal expansion or thermal/material gradients, and/or shifting the resonant frequency of the probe by thermal expansion changing the mass distribution of the cantilever probe structure or temperature dependent changes in the elasticity of the materials used in the cantilever probe structure. Second, optical force, such as an optical trapping force arising near the beam waist of a focused beam, on the probe tip can deflect the cantilever probe. Optical trapping force is described in detail in “Optical trapping” by Keir C. Neuman and Steven M. Block, Review of Scientific Instruments, volume 75, pages 2787-2809 September 2004. (doi: 10.1063/1.1785844). FIG. 2 illustrates a beam waist 202 of a focused light beam 204, a tip 206 of a probe 208 on a cantilever 210 of a scanning probe microscope, and the direction 212 of the resulting trapping force Fₒ. As shown in FIG. 2, the tip 206 of a cantilever probe is positioned near the beam waist 202 of a focused light beam. An optical trapping force acts on a microscopic body to push it toward a position near the center of the beam waist. Thus, an optical trapping force Fₒ acts on the tip to push it toward the central region of the beam waist. The vertical component of this force deflects the cantilever downward. Third, a force gradient on the probe generated by the presence of the optical beam can shift a resonance frequency of the cantilever probe. Such a force gradient may occur near the beam waist of focused beam along with an optical trapping force. If the intensity of the optical beam is modulated at a frequency, the first two effects above can cause the cantilever probe to vibrate.

With a focused optical beam directed at the probe tip in free space, by observing the amplitude and/or phase (relative to the modulation) of the probe vibration, a preferred position of the beam focus relative to the tip of the probe can be determined. For example, the preferred focus position can be chosen by choosing the position where the vibration amplitude is maximum. Alternatively, by engaging in a careful study of the position of the focus relative to the tip and how this affects the performance of the scanning probe microscope in its targeted operating mode, a specific location of the focus relative to the tip can be established as the preferred focus location.

The third effect above (frequency shift caused by force gradient arising from the optical beam) does not require that the beam be modulated, although the beam may be modulated. A preferred focus location can be established by observing how a resonance frequency of a vibrational mode of the cantilever shifts as a function of focus position, due to the effect of gradient arising from the optical beam. For example, if the focus position of a beam is adjusted relative to the tip of the probe, a preferred position can be chosen as the point where frequency shift of the cantilever (relative to the case of no illumination) is maximum. Alternatively, a preferred position can be chosen as a position a certain distance away from the point of maximum frequency shift, or by choosing a position with a specific amount of frequency shift.

The resonance frequencies of the cantilever probe can be measured in a variety of methods, such as:
1. observing the peak amplitude of thermal excitation as a function of frequency, and identifying peak frequencies as the resonance frequencies.
2. driving the cantilever either with the modulated light source, or with another source, such as a piezoelectric element, and finding the peak amplitude response as a function of frequency.
3. driving the cantilever either with the modulated light source, or with another source, such as a piezoelectric element, and measuring the phase shift (relative to the driving excitation) as a function of frequency.
4. driving the cantilever either with the modulated light source, or with another source, and locking the driving frequency to the resonance frequency using a phase-locked-loop, or by using the resonance as the frequency-determining factor in a self-oscillating system.
5. driving the cantilever probe with multiple frequencies simultaneously, such as exciting the probe with a piezo driven by a white noise source, and measuring the frequency content of the resulting probe vibration (for example, by performing a Fourier transform on the cantilever deflection signal) and identifying the frequency of peak amplitude as the resonance frequency.

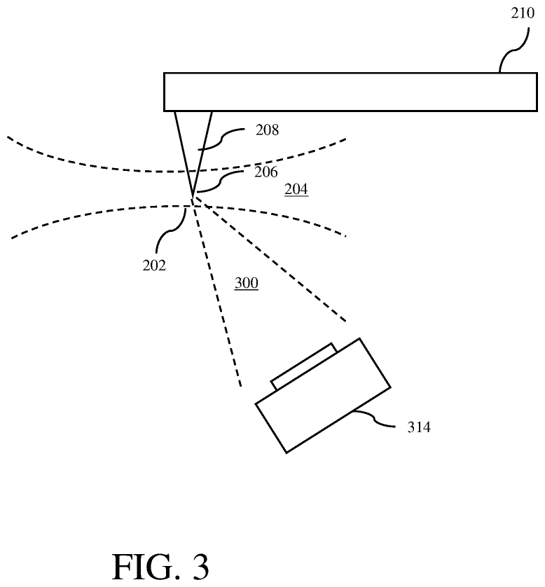

Instead of detecting mechanical motion or properties of the probe, an alternative is to detect light scattered by the probe tip in the presence of the focused incoming beam. As illustrated in FIG. 3, if the probe tip 206 enters the beam of light 204, some scattered light 300 may be generated and detected by a sensitive photon detector 314, such as a photodiode (for visible and near infrared light) or a mercury cadmium telluride (MCT) detector. The intensity of scattered light is proportional to the intensity of the incoming light, so scattering will be greatest at the beam waist, i.e., the scattering is maximized when the tip is in the most intense region of the incoming beam (i.e., at the beam waist).

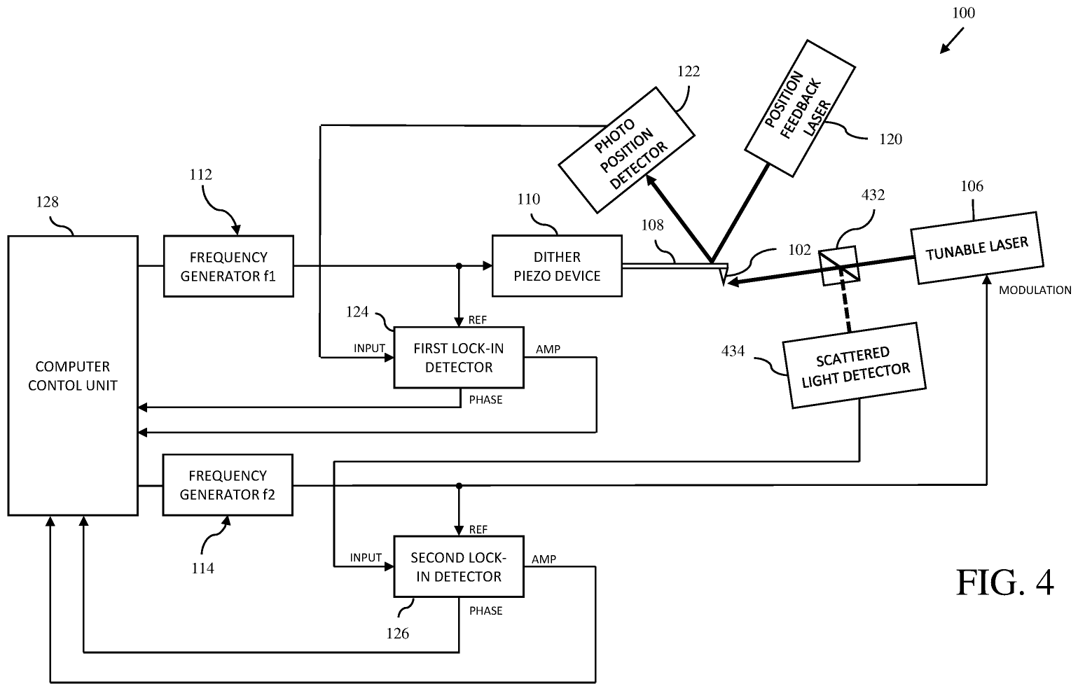

In a scanning probe microscope, a beamsplitter may be used to detect the scattered light from the probe without the presence of a sample. This is illustrated in FIG. 4, which shows the scanning probe microscope 100 with a beamsplitter 432, which is positioned to direct scattered light from the probe 102 to a scattered light detector 434. The detected scatter light signal can be input to the second lock-in detector 126 to measure amplitude and/or phase of the signal using the modulation signal from the frequency generator 114 as a reference. In FIG. 4, the sample z piezo device 116, the sample z controller 118 and the optical system 130 are not shown.

The sensitivity of the scattered light measurement can be improved by vibrating the cantilever (for example, with a piezoelectric element) so that the tip's position relative to the beam waist is oscillating. Use of lock-in detection can suppress the signal from background light, maximizing signal to noise ratio for measuring the intensity of the scattered light.

A further enhancement of the optical detection system is to use an interferometer in place of the simple optical detector 314 shown in FIG. 3. Such an interferometer is useful if a coherent light source such as a laser is used. A portion of the incoming light beam is interfered with the scattered light, allowing both amplitude and phase measurements of the scattered light, which can provide additional information for performing the alignment of the incoming beam to the probe tip.

For both mechanical and optical detection of the interaction of the focused light with the probe tip, the optimal alignment may not simply correspond to the position of the tip that provides maximum vibration, frequency shift, or scattered light intensity. Since the tip is not a simple point, but rather a body that extends upward from the tip (the shank of the tip) in a generally conical or pyramidal shape, some response is expected not just when the tip is near the center of the beam waist, but also when the shank is illuminated. By nature of field enhancement that occurs near the sharp tip, it is likely that there is a local maximum in the magnitude of the effect when the tip is near the center of the waist, but the tip position corresponding to the local maximum of response may as a result of the shank interaction be offset, with a nonzero response with additional local maxima as the shank of the probe and even the cantilever beam are illuminated. The ideal alignment position can be determined empirically by testing various tip positions relative to the position of maximum response and checking the performance of the microscopy technique being used. For example, with PiFM, after alignment to a trial position, the sample surface can be brought into proximity with the tip (leaving the alignment of the incoming focused light beam unchanged) and measuring the magnitude of the PiFM signal, the fidelity of an absorption spectrum, or some similar metric for evaluating the particular alignment position relative to other positions. After such an empirical study, a best alignment position (relative to the position of maximum response) may be determined and used routinely.

Depending on the type of light source being used, the position of the focused beam waist in space (relative to the source) may or may not be fixed. Particularly with tunable sources, such as a quantum cascade laser as typically used as a tunable infrared source for PiFM, small variations in the pointing or focus of the laser may cause the beam waist position to move while sweeping through the wavelength tuning range of the light source during the acquisition of a spectrum. The misalignment resulting from such dynamic changes in beam waist position can be dynamically corrected. Measurements gathered during a free space tip alignment procedure can be used to perform such dynamic alignment.

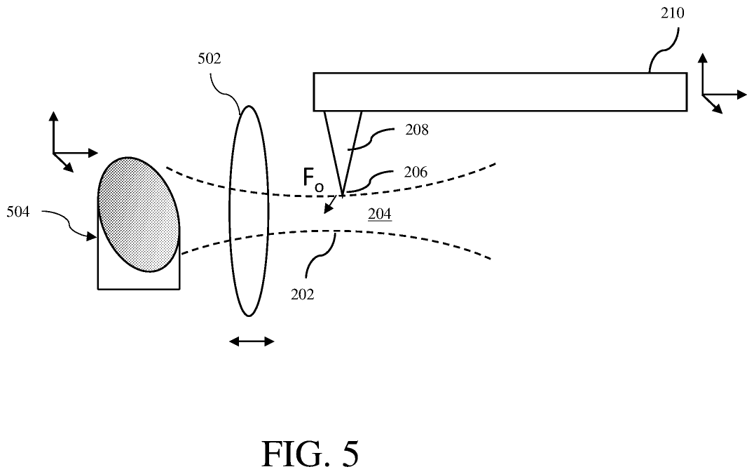

An example of using free space alignment measurements to perform dynamic correction of beam alignment is as follows. With a tunable light source, at multiple different wavelengths, perform a measurement of probe vibration amplitude, vibration phase, resonance frequency, or scattered light intensity/phase as a function of beam waist position by scanning the position of a focusing element, the angle of a steering mirror, or a combination of the two, which is illustrated in FIG. 5. As shown in FIG. 5, the position of a focusing element 502 can be scanned and the angle of a steering mirror 504 can be changed. The focusing element 502 and the steering mirror 504 may be part of the optical system 130 in the scanning probe microscope 100 shown in FIG. 1. At each wavelength, record the best aligned position relative to the control signals for the focusing element and/or steering mirror. While sweeping through some or all of the tuning range of the light source during the acquisition of a spectrum, adjust the position of the focusing element and/or the angle of the steering mirror to keep the beam waist position well aligned to the tip.

The number of wavelengths at which alignment measurements need to be done depends on the behavior of the pointing and focus variation of the light source as it is tuned through its range of wavelengths. If high complex behavior is seen (i.e., behavior that cannot be easily approximated from measuring at a small number of wavelengths), a large number of alignment measurements must be made as a function of wavelength.

In most tunable light sources, there is a unique power output as a function of wavelength. This unique power output is characteristic to the individual light source module. Although in principle it is possible to measure the power as a function of wavelength using a conventional power meter, such an approach may not be representative of the effective fluence on the tip. The alignment of the optical system and the optical components between the light source and the imaging location can influence the optical fluence on the imaging probe and spectroscopic response on the sample, as can the physical properties of the particular probe tip in use in the experiment. To successfully normalize either mathematically or in real time by use of an optical attenuation system, the optical response of the cantilever will need to be characterized as a function of wavelength. The recorded power profile as a function wavelength can be used in various ways including independent methods or in combination of methods for the normalization of the optical response of the sample. First the measurement of the optical response of the cantilever as a function of wavelength with the probe away from the sample surface is required where the resulting spectrum is the power profile for the tunable light source. Moreover, it may be advantageous to record the power profile using a fixed percentage attenuation for cases where high-power light sources that could cause damage to the probe.

Once the power profile is recorded any resulting spectra taken on the sample surface can be normalized by various methods, such as:
1. Actively adjust the power at the tip-sample interface using a rotatable polarizer or other controllable attenuation devices (for example: neutral density filters, acoustic optical modulators or electro optical modulators), or by controllable internal parameters of the light source (for example: pulse duration, power output) where the positions/settings of the polarizer or other controllable attenuation device are predetermined mathematically by the power profile recorded far away from the sample surface.
2. Mathematically divide the spectroscopic response at the tip-sample interface by the power profile as a function of wavelength.
3. For measurements where the power profile is lower at some wavelength regions than the requested maximum polarizer or other controllable attenuation transmission, the resulting spectrum can be post processed mathematically with the known attenuation device position/settings as a function of wavelength and power profile.

In most SPM techniques that rely on optical illumination of the tip-sample interface, the light source is modulated or pulsed at a frequency to enhance the signal to noise ratio. For many tunable laser sources, the intensity profile varies for different modulation or pulse frequencies and pulse durations, which in turn will produce varying local fluence profile at different modulation or pulse frequency. Since different SPM measurement schemes require different modulation (or pulse) frequency, it is important that the local fluence measurements are collected at frequencies close to the modulation (or pulse) frequency and pulse duration utilized in the actual measurement to achieve the best normalization. For example, in one scheme, the probe may be tracking the topography of the sample by using the second resonance mode of the cantilever while the laser is pulsed at the first resonance frequency of the cantilever. Yet in another scheme, the probe may be tracking the topography of the sample by using the second resonance mode of the cantilever while the laser is pulsed at the difference between the second and first resonance frequencies of the cantilever even though the optical response is measured at the first resonance frequency of the cantilever; in this scheme, the non-linear behavior of the optical response as a function of tip-sample gap spacing mixes with the optical response due to the periodic laser pulses to produce a measurable signal at the difference frequency, which is the first resonance frequency due to the choice of the pulse frequency. In the latter scheme where the mixing occurs, the power profile cannot be measured effectively at the pulse frequency since the probe will not respond effectively, and the power profile is measured at the second resonance frequency, which is much closer to the actual pulse frequency than the first resonance frequency. The use of first and second resonances in these examples is to demonstrate the concept, and other pairs of resonances can be used in a similar manner.

When using a tunable light source, the requested sweep speed must be considered. Since the probe used in most SPM techniques is based on a mechanical resonator it is important to consider the response time based on its quality factor. Therefore, for accurate recording of the spectral response of the probe as a function of wavelength, the sweep speed of the light source needs to be controlled such that the resonator can respond to the changing power as the wavelength is changed. Similar considerations are required with any motorized or electronically controlled attenuation system. Based on the rate of change in optical output power as a function of wavelength, sweep speed of the wavelength will need to be considered such that there is sufficient time for the motor or electronic slew rate to properly track the changing output power.

By using the methods described above, a reproducible and reliable method for both static and dynamic alignment of the beam waist or a focused beam to the tip of the cantilever probe can reliably be achieved. With this alignment, recording the power profile of the light source as a function of wavelength at the probe removes the effects of laser power variation, optical losses in the beam path and spot size as a function of wavelength.

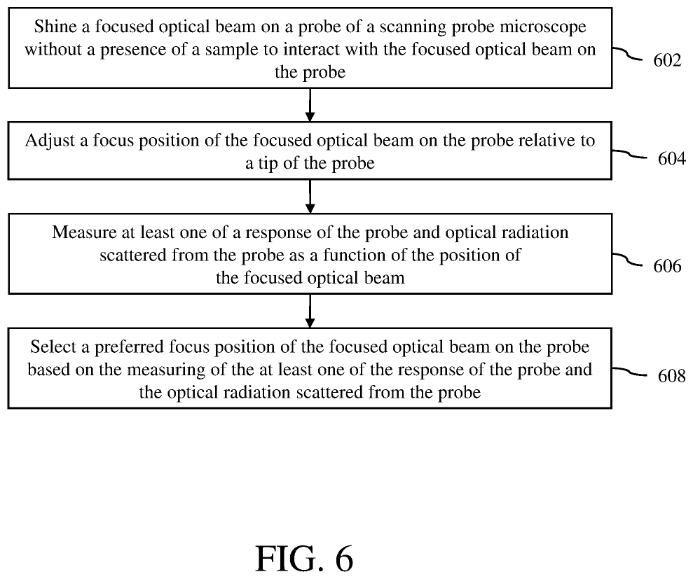

Turning now to FIG. 6, a flow diagram of a method of operating a scanning probe microscope, such as the scanning probe microscope 100, using a focused optical beam on a probe of the scanning probe microscope in accordance with an embodiment of the invention is shown. As used herein, the method of operating the scanning probe microscope includes any calibration steps, such as aligning a focused beam on the probe of the microscope and measuring the local fluence on the tip, as well as any sample measurement steps, such as imaging the topography of a sample and measuring optical or other sample properties in the near field region around the tip, and any post-sampling steps, such as processing sample measurement data.

At step, 602, the focused optical beam is shined on the probe of the scanning probe microscope without a presence of a sample to interact with the focus optical beam on the probe. In an embodiment, the focused optical beam is shined on the probe of the scanning probe microscope without a sample being placed on the scanning probe microscope or without a sample being near the probe of the scanning probe microscope to optically and/or thermally interact with the illuminated probe.

At step 604, a focus position of the focused optical beam on the probe relative to a tip of the probe is adjusted. In an embodiment, the adjustment may involve changing the angle of a steering mirror and/or changing the position of a focusing element, which are situated between a light source, i.e., a laser, and the probe.

At step 606, at least one of a mechanical response of the probe and optical radiation scattered from the probe as a function of the position of the focused optical beam is measured. The measurement of the mechanical response of the probe may be the amplitude or phase of probe vibration relative to a driving frequency on the cantilever on which the probe is attached. The measurement of the scattered optical radiation or light may be the intensity of the scattered optical radiation.

At step 608, a preferred focus position of the focused optical beam on the probe is selected based on the measuring of the at least one of the mechanical response of the probe and the optical radiation scattered from the probe. This preferred focus position of the focused optical beam on the probe can then be used to measure properties of a sample of interest using the scanning probe microscope.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method of operating a scanning probe microscope using a focused optical beam on a probe of the scanning probe microscope, the method comprising:
shining the focused optical beam on the probe of the scanning probe microscope without a presence of a sample to interact with the focused optical beam on the probe;
adjusting a focus position of the focused optical beam on the probe relative to a tip of the probe;
measuring at least one of a response of the probe and optical radiation scattered from the probe as a function of the position of the focused optical beam; and
selecting a preferred focus position of the focused optical beam on the probe based on the measuring of the at least one of the response of the probe and the optical radiation scattered from the probe.

2. The method of claim 1, wherein selecting the preferred focus position of the focused optical beam on the probe comprises:
modulating the intensity of the optical beam intensity to produce modulated optical beam;
measuring the amplitude of vibration of the probe in response to the modulated optical beam as a function of the focus position; and
selecting the preferred focus position based on the measured amplitude.

3. The method of claim 2, wherein the preferred focus position is a focus position at which the amplitude of vibration of the probe is maximum.

4. The method of claim 1, wherein selecting the preferred focus position of the focused optical beam on the probe comprises:
modulating the intensity of the optical beam intensity to produce modulated optical beam,
measuring the phase of vibration of the probe in response to the modulated optical beam relative to the phase of the modulation; and
selecting the preferred focus position of the beam based on measured phase relationship.

5. The method of claim 1, wherein selecting the preferred focus position of the focused optical beam on the probe comprises:
vibrating the probe at a driving frequency with a driving source other than a modulation frequency of the optical beam;
measuring the amplitude of vibration of the cantilever at the driving frequency; and
selecting the preferred focus position based on the vibration amplitude measurement.

6. The method of claim 1, wherein selecting the preferred focus position of the focused optical beam on the probe comprises:
vibrating the probe at a driving frequency with a driving source other than a modulation frequency of the optical beam;
measuring the phase of vibration of the cantilever at the driving frequency relative to the phase of the driving source as a function of the focus position; and
selecting the preferred focus position based on a measured phase relationship between the phase of vibration of the cantilever and the phase of the driving source.

7. The method of claim 1, wherein selecting the preferred focus position of the focused optical beam on the probe comprises:
measuring the resonance frequency of a vibrational mode of the probe as a function of focus position; and
selecting the preferred focus position based on the measured resonance frequency.

8. The method of claim 7, wherein measuring the resonance frequency of the vibrational mode of the probe includes measuring a peak amplitude of thermal excitation of the probe or a frequency of maximum amplitude, or a Fourier transform of the thermal excitation of the probe.

9. The method of claim 7, wherein measuring the resonance frequency of the vibrational mode of the probe comprises:
driving vibration of the probe by a means other than the optical beam;
sweeping a driving frequency on the probe through a range expected to include the resonance frequency; and
measuring the driving frequency at which a peak amplitude of excitation occurs.

10. The method of claim 7, wherein measuring the resonance frequency of the vibrational mode of the probe comprises driving vibration of the probe by a means other than the optical beam, with the resonance frequency of the probe vibration controlling the frequency of vibration.

11. The method of claim 7, wherein measuring the resonance frequency of the vibrational mode of the probe comprises driving the vibration of the probe by a means other than the optical beam, performing a Fourier transform of the vibration signal, and selecting the resonance frequency based on a peak of the Fourier transform.

12. The method of claim 1, further comprising:
bringing a sample surface into measuring proximity with the probe tip with focus position of the beam adjusted according to the preferred focus position determined without the sample present; and
measuring one or more probe responses with respect to the sample surface.

13. A method of operating a scanning probe microscope using a focused optical beam on a probe of the scanning probe microscope, the method comprising:
shining the focused optical beam on the probe of the scanning probe microscope without a presence of a sample to interact with the focused optical beam on the probe;
adjusting a focus position of the focused optical beam on the probe relative to a tip of the probe;
measuring a response of the probe as a function of the position of the focused optical beam; and
selecting a preferred focus position of the focused optical beam on the probe based on the measuring of the response of the probe.

14. The method of claim 13, wherein selecting the preferred focus position of the focused optical beam on the probe comprises:
modulating the intensity of the optical beam intensity to produce modulated optical beam;
measuring the amplitude of vibration of the probe in response to the modulated optical beam as a function of the focus position; and
selecting the preferred focus position based on the measured amplitude.

15. The method of claim 13, wherein selecting the preferred focus position of the focused optical beam on the probe comprises:
modulating the intensity of the optical beam intensity to produce modulated optical beam,
measuring the phase of vibration of the probe in response to the modulated optical beam relative to the phase of the modulation; and
selecting the preferred focus position of the beam based on measured phase relationship.

16. The method of claim 13, wherein selecting the preferred focus position of the focused optical beam on the probe comprises:
vibrating the probe at a driving frequency with a driving source other than a modulation frequency of the optical beam;
measuring the amplitude of vibration of the cantilever at the driving frequency; and
selecting the preferred focus position based on the vibration amplitude measurement.

17. The method of claim 13, wherein selecting the preferred focus position of the focused optical beam on the probe comprises:
vibrating the probe at a driving frequency with a driving source other than a modulation frequency of the optical beam;
measuring the phase of vibration of the cantilever at the driving frequency relative to the phase of the driving source as a function of the focus position; and
selecting the preferred focus position based on a measured phase relationship between the phase of vibration of the cantilever and the phase of the driving source.

18. The method of claim 13, wherein selecting the preferred focus position of the focused optical beam on the probe comprises:
measuring the resonance frequency of a vibrational mode of the probe as a function of focus position; and
selecting the preferred focus position based on the measured resonance frequency.

19. The method of claim 13, further comprising:
bringing a sample surface into measuring proximity with the probe tip with focus position of the beam adjusted according to the preferred focus position determined without the sample present; and
measuring one or more probe responses with respect to the sample surface.

20. A scanning probe microscope comprising:
a cantilever with a probe;
a light source to irradiate the probe with a focused optical beam;
an optical system to adjust a focus position of the focused optical beam on the probe;
a dither device connected to the cantilever to drive the cantilever to vibrate;
an optical detection system to measure a response of the probe with respect to the focused optical beam; and
a control unit connected to the optical system and the optical detection system to select a preferred focus position of the focused optical beam on the probe based on the measured response of the cantilever for different adjusted focus positions of the focused optical beam on the probe.
